(19) United States
(12) Patent Application Publication
(10) Pub. No.: US 2014/0120897 A1
(43) Pub. Date: May 1, 2014

(54) COMMUNICATION INTEGRATION SYSTEM AND METHOD THEREOF

(71) Applicant: YOMORE TECHNOLOGY CO., LTD., Kaohsiung City (TW)

(72) Inventors: Jao-Ching Lin, KAOHSIUNG CITY (TW); Wen-Ting Lee, KAOHSIUNG CITY (TW); Chun-Kai Ni, KAOHSIUNG CITY (TW)

(73) Assignee: YOMORE TECHNOLOGY CO., LTD., Kaohsiung City (TW)

(21) Appl. No.: 14/067,915

(22) Filed: Oct. 30, 2013

(30) Foreign Application Priority Data
Oct. 31, 2012 (TW) 101140262

(51) Int. Cl. H04W 88/04

(52) U.S. Cl. CPC H04W 88/04
USPC 455/418

(57) ABSTRACT

A communication integration system includes a first portable device and a second portable device. Wherein when the first portable device utilizes a first mobile communication module to communicate with a communication device, a first communication coupling module of the first portable device transmits communication data and first voice data received by the first portable device to a second communication coupling module of the second portable device, so as to display the communication data and play the first voice data on the second portable device, and the second communication coupling module transmits second voice data of the second portable device to the first communication coupling module, so as to transmit the second voice data to the communication device via the first mobile communication module.

### BACKGROUND OF THE INVENTION

1. Field of the Invention

The present invention relates to a communication integration system, and more particularly, to a communication integration system comprising a plurality of mutually integrated mobile communication devices.

2. Description of the Prior Art

As related technology keeps improving, many kinds of mobile phones are gradually developed. A current mobile phone comprises a mobile communication module configured to perform communication via a mobile communication network. When a user needs to use different mobile communication networks to communicate, the user must bring a plurality of mobile phones or a dual-SIM mobile phone.

However, bringing a plurality of mobile phones may increase weight, and the plurality of mobile phones may also occupy lots of space, so as to cause inconvenience. Moreover, when there is an incoming call, the user usually can not recognize which mobile phone receiving the incoming call, such that it is inconvenient to answer the incoming call.

On the other hand, when bringing the dual-SIM mobile phone, the user usually needs to complete complex operations for switching to a different mobile communication network to communicate. In addition, the dual-SIM mobile phone comprises two mobile communication modules, such that when the user uses the dual-SIM mobile phone, the user may suffer more electromagnetic radiation, and the two mobile communication modules may interfere with each other.

Therefore, it is an important topic to develop a communication integration system comprising a plurality of mutually integrated mobile communication devices for solving the above problems.

### SUMMARY OF THE INVENTION

The present invention provides a communication integration system, comprising a first portable device, and a second portable device. The first portable device comprises a first mobile communication module configured to perform communication via a first mobile communication network, and a first communication coupling module coupled to the first mobile communication module. The second portable device comprises a second mobile communication module configured to perform communication via a second mobile communication network, and a second communication coupling module configured to link with the first communication coupling module, and the second communication coupling module is coupled to the second mobile communication module. Wherein when the first portable device utilizes the first mobile communication module to perform a communication operation with a communication device, the first communication coupling module transmits communication data and first voice data received by the first portable device to the second communication coupling module, so as to display the communication data and play the first voice data on the second portable device, and the second communication coupling module transmits second voice data of the second portable device to the first communication coupling module, so as to transmit the second voice data to the communication device via the first mobile communication module.

The present invention further provides a communication integration method, comprising linking a first portable device to a second portable device, the first portable device comprising a first mobile communication module configured to perform communication via a first mobile communication network, and a first communication coupling module coupled to the first mobile communication module, the second portable device comprising a second mobile communication module configured to perform communication via a second mobile communication network, and a second communication coupling module configured to link with the first communication coupling module, the second communication coupling module being coupled to the second mobile communication module ; utilizing the first mobile communication module to communicate with a communication device; transmitting communication data and first voice data received by the first portable device to the second communication coupling module; displaying the communication data and playing the first voice data on the second portable device ; transmitting second voice data of the second portable device to the first communication coupling module; and transmitting the second voice data from the first mobile communication module to the communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a communication integration system of the present invention integrating a plurality of mobile communication devices.

FIG. 2 is a diagram showing a first embodiment of the communication integration system of the present invention.

FIG. 3 is a diagram showing the communication integration system of the present invention performing a communication operation with a communication device.

FIG. 4 is a diagram showing a second embodiment of the communication integration system of the present invention.

FIG. 5 is a flowchart showing a communication integration method of the present invention.

### DETAILED DESCRIPTION

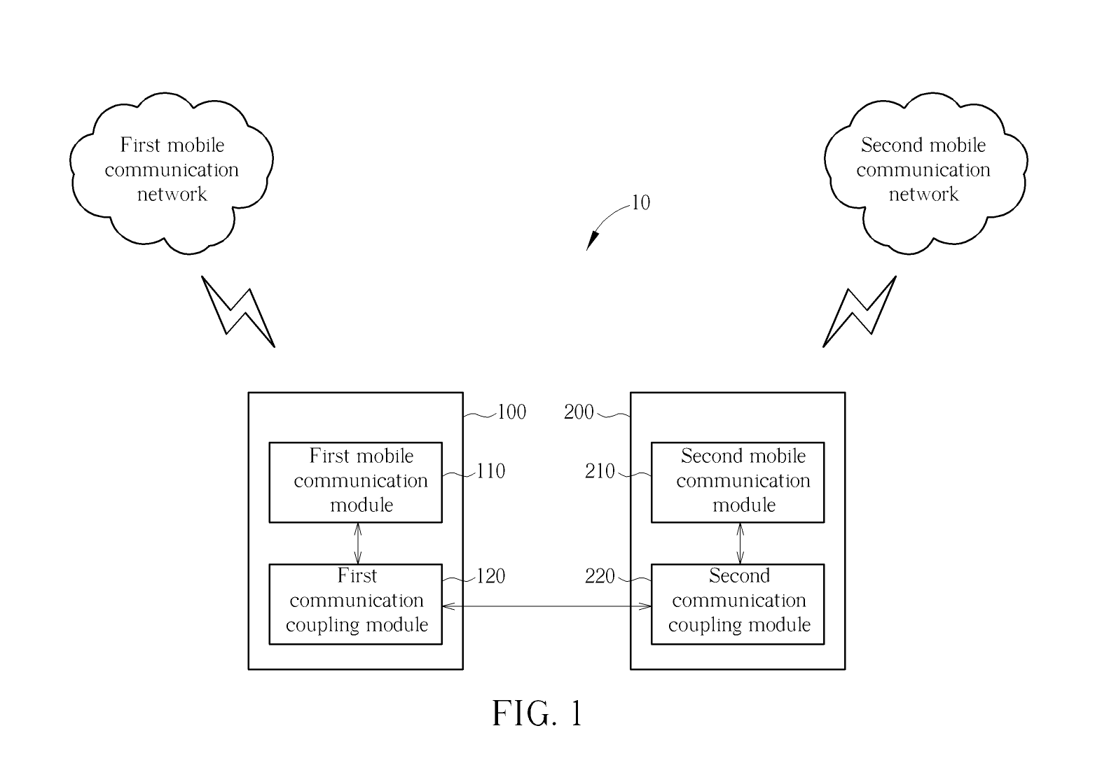

Please refer to FIG. 1. FIG. 1 is a diagram showing a communication integration system of the present invention integrating a plurality of mobile communication devices. As shown in FIG. 1, the communication integration system of the present invention comprises at least two mobile communication devices, such as a first portable device 100 and a second portable device 200. The first portable device 100 comprises a first mobile communication module 110 and a first communication coupling module 120. The first mobile communication module 110 is configured to perform communication via a first mobile communication network. The first communication coupling module 120 is coupled to the first mobile communication module 110. The second portable device 200 comprises a second mobile communication module 210 and a second communication coupling module 220. The second mobile communication module 210 is configured to perform communication via a second mobile communication network. The second communication coupling module 220 is coupled to the second mobile communication module 210. The first communication coupling module 120 is linked with the second communication coupling module 220.

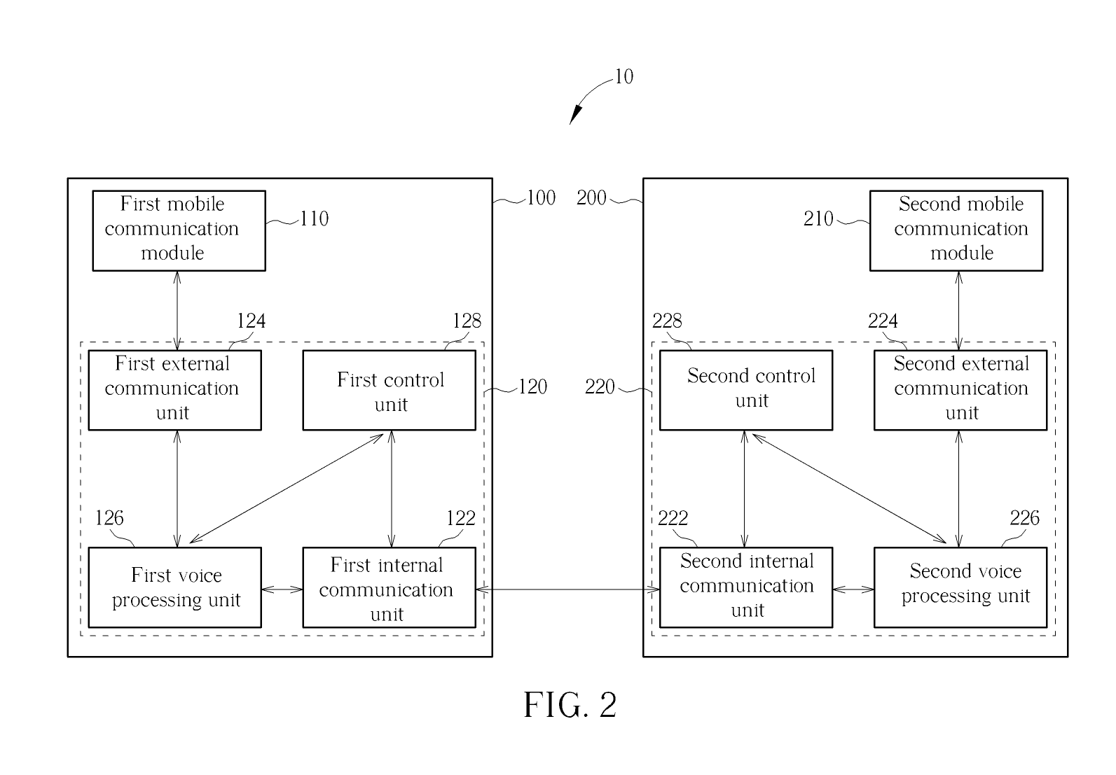

Please refer to FIG. 2, and refer to FIG. 1 as well. FIG. 2 is a diagram showing a first embodiment of the communication integration system of the present invention. As shown in FIG. 2, the first communication coupling module 120 comprises a first internal communication unit 122, a first external communication unit 124, a first voice processing unit 126, and a first control unit 128. The first external communication unit 124 is configured to control the first mobile communication module 110 to perform communication via the first mobile communication network. The first voice processing unit 126 is configured to convert voice data received by the first portable device 100 into audio signals (such as audio signals of a speaker) for playing back, and convert audio signals (such as audio signals of a microphone) received by the first portable device 100 into voice data for data transmission. The first control unit 128 is configured to control the first internal communication unit 122, the first external communication unit 124 and the first voice processing unit 126.

Similarly, the second communication coupling module 220 comprises a second internal communication unit 222, a second external communication unit 224, a second voice processing unit 226, and a second control unit 228. The first and second internal communication units 122, 222 can be linked through an internal transmission means, and the internal transmission means comprises (but not limited to) digital enhanced cordless telecommunication (DECT), Wi-Fi, Bluetooth, Zigbee, infrared, universal serial bus (USB) or Ethernet . The second external communication unit 224 is configured to control the second mobile communication module 210 to perform communication via the second mobile communication network. The second voice processing unit 226 is configured to convert voice data received by the second portable device 200 into audio signals (such as audio signals of a speaker) for playing back, and convert audio signals (such as audio signals of a microphone) received by the second portable device 200 into voice data for data transmission. The second control unit 228 is configured to control the second internal communication unit 222, the second external communication unit 224 and the second voice processing unit 226.

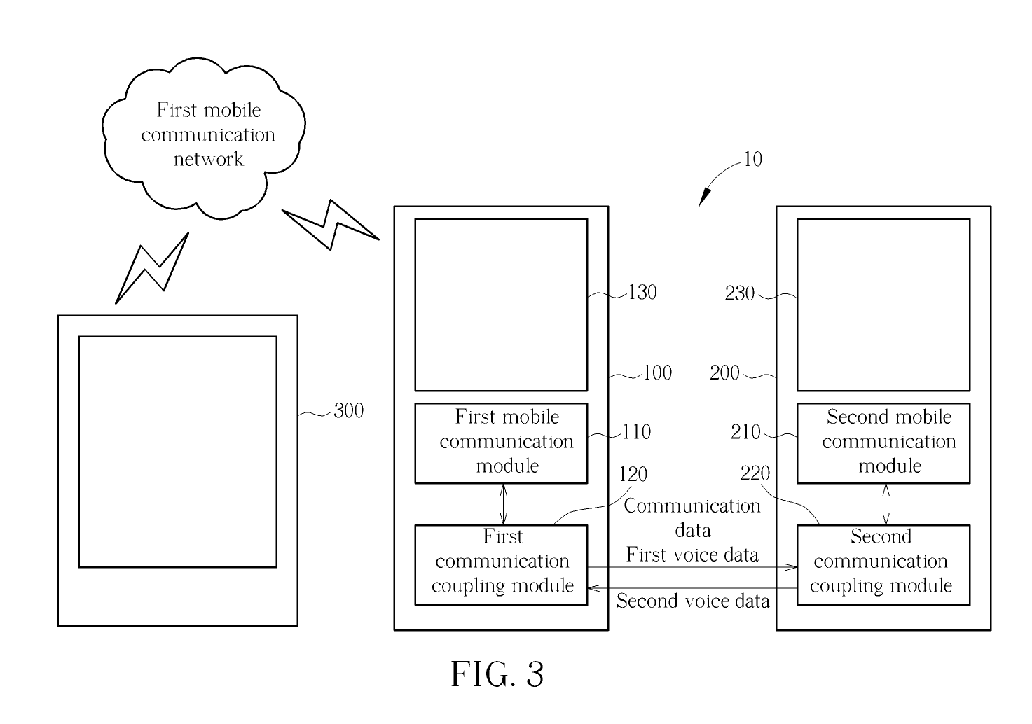

According to the above arrangement, the communication integration system 10 of the present invention can integrate the first portable device 100 with the second portable device 200, such that a user only needs to bring one of the mobile communication devices 100, 200 for using different mobile communication networks to communicate. For example, please refer to FIG. 3, and refer to FIG. 2 as well. FIG. 3 is a diagram showing the communication integration system 10 of the present invention performing a communication operation with a communication device 300. As shown in FIG. 3, when the first portable device 100 utilizes the first mobile communication module 110 to perform a communication operation with a communication device 300, the first control unit 128 of the first communication coupling module 120 transmits communication data and first voice data received by the first portable device 100 to the second internal communication unit 222 of the second communication coupling module 200 via the first internal communication unit 122. The second control unit 228 of the second communication coupling module 220 then displays the communication data transmitted from the first communication coupling module 120 on a screen 230 of the second communication coupling module 200, and controls the second voice processing unit 226 to convert the first voice data into audio signals of a speaker for playing back. The second control unit 228 of the second communication coupling module 220 also controls the second voice processing unit 226 to convert audio signals of a microphone of the second communication coupling module 200 into second voice data, and transmits the second voice data to the first internal communication unit 122 of the first communication coupling module 120 via the second internal communication unit 222. Thereafter, the first external communication unit 124 of the first communication coupling module 120 transmits the second voice data to the communication device 300 via the first mobile communication module 110.

Therefore, the second portable device 200 can communicate with the communication device 300 via the first portable device 100, the user only needs to bring the second portable device 200 to communicate via different mobile communication networks. In addition, the way of the first portable device 100 utilizing the first mobile communication module 110 to communicate with the communication device 300 can be the second portable device 200 controlling the first portable device 100 via the first and second communication coupling modules 120, 220, for utilizing the first mobile communication module 110 to communicate with the communication device 300, such as controlling the first portable device 100 to answer an incoming call from the communication device 300, or controlling the first portable device 100 to make a call to the communication device 300.

On the other hand, since the first portable device 100 and the second portable device 200 have identical architecture, the above procedures can be reversed, that is, the first portable device 100 can control the second portable device 200 via the first and second communication coupling modules 120, 220, for utilizing the second mobile communication module 210 to communicate with the communication device 300.

Besides communication operations, the first portable device 100 and the second portable device 200 can mutually transmit data via the first communication coupling module 120 and the second communication coupling module 220, wherein the data can be phone book data, social network data, Internet communication data and/or short message data.

In addition, the first communication coupling module 120 and the second communication coupling module 220 can be built by software or firmware, or the first communication coupling module 120 and the second communication coupling module 220 can be periphery devices external to the first portable device 100 and the second portable device 200 respectively, or the first communication coupling module 120 and the second communication coupling module 220 can be embedded hardware of the first portable device 100 and the second portable device 200.

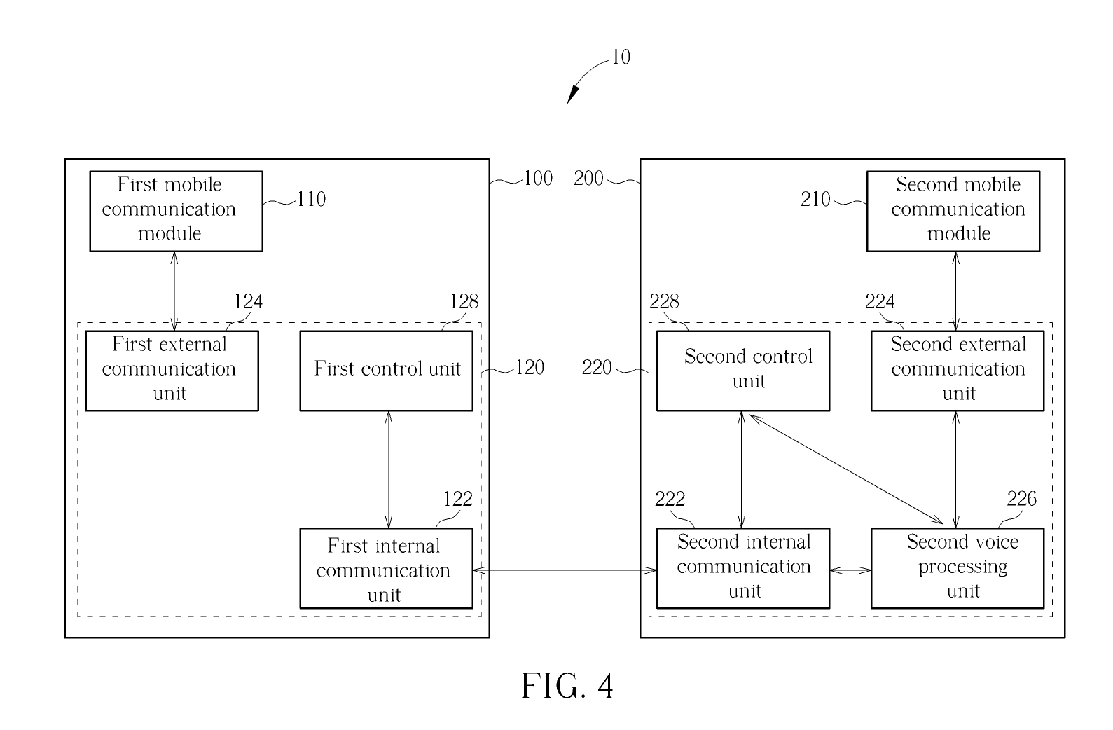

In the embodiment of FIG. 2, the first portable device 100 and the second portable device 200 are mobile phones. However, in other embodiments of the present invention, one of the mobile communication devices can be an electronic device only comprising a mobile communication module without any other function, such as a display function, an input function, or an audio playback function. Please refer to FIG. 4. FIG. 4 is a diagram showing a second embodiment of the communication integration system of the present invention. As shown in FIG. 4, the first portable device 100 only comprises a mobile communication module without the display function, the input function, or the audio playback function, such that the first communication coupling module 120 of the first portable device 100 only comprises the first internal communication unit 122, the first external communication unit 124, and the first control unit 128 without the voice processing unit. According to the above arrangement, size and weight of the first portable device 100 can be greatly reduced. If the user brings the first portable device 100 and the second portable device 200 together, loading of the user can be reduced.

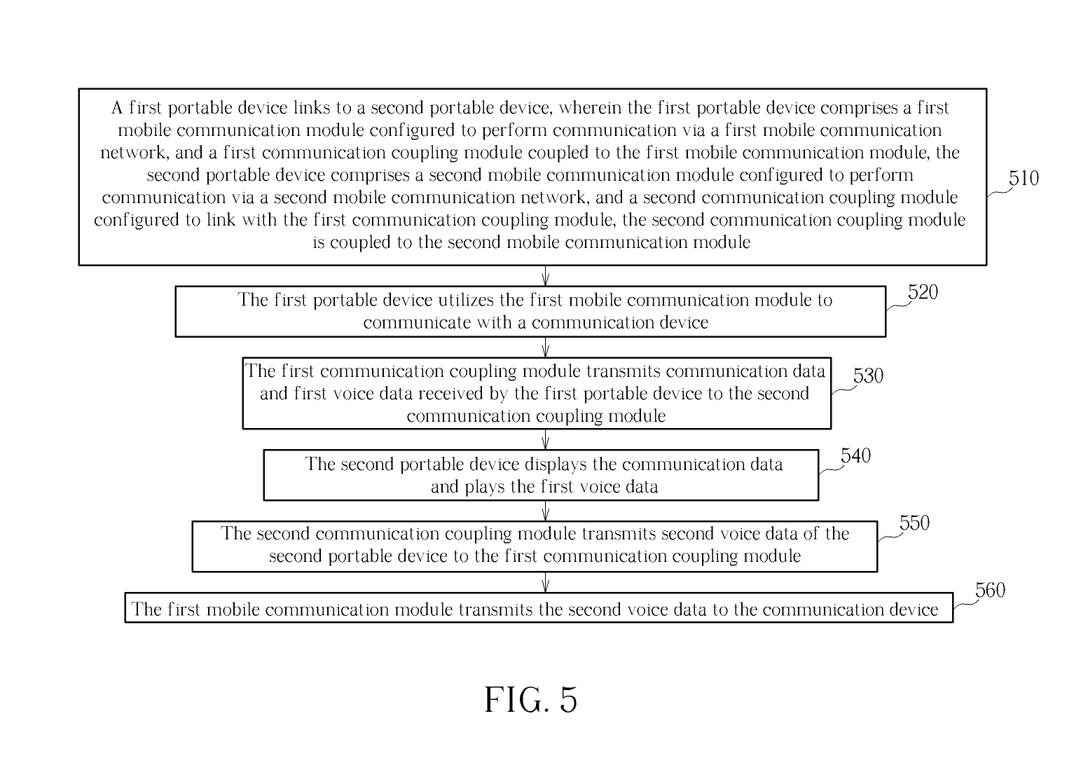

Please refer to FIG. 5. FIG. 5 is a flowchart 500 showing a communication integration method of the present invention. The flowchart of the communication integration method of the present invention comprises the following steps:

Step 510: A first portable device links to a second portable device, wherein the first portable device comprises a first mobile communication module configured to perform communication via a first mobile communication network, and a first communication coupling module coupled to the first mobile communication module, the second portable device comprises a second mobile communication module configured to perform communication via a second mobile communication network, and a second communication coupling module configured to link with the first communication coupling module, the second communication coupling module is coupled to the second mobile communication module;

Step 520: The first portable device utilizes the first mobile communication module to communicate with a communication device;

Step 530: The first communication coupling module transmits communication data and first voice data received by the first portable device to the second communication coupling module;

Step 540: The second portable device displays the communication data and plays the first voice data;

Step 550: The second communication coupling module transmits second voice data of the second portable device to the first communication coupling module; and

Step 560: The first mobile communication module transmits the second voice data to the communication device.

In contrast to the prior art, the communication integration system of the present invention can integrate a plurality of mobile communication devices, and utilize one of the mobile communication devices to control other mobile communication devices to perform communication operations. Therefore, the user can use different mobile communication networks to communicate without bringing a plurality of mobile communication devices, so as to increase convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication integration system, comprising:
a first portable device, comprising:
a first mobile communication module, configured to perform communication via a first mobile communication network; and
a first communication coupling module, coupled to the first mobile communication module; and
a second portable device, comprising:
a second mobile communication module, configured to perform communication via a second mobile communication network; and
a second communication coupling module, configured to link with the first communication coupling module, the second communication coupling module being coupled to the second mobile communication module;
wherein when the first portable device utilizes the first mobile communication module to perform a communication operation with a communication device, the first communication coupling module transmits communication data and first voice data received by the first portable device to the second communication coupling module, so as to display the communication data and play the first voice data on the second portable device, and the second communication coupling module transmits second voice data of the second portable device to the first communication coupling module, so as to transmit the second voice data to the communication device via the first mobile communication module.

2. The communication integration system of claim 1, wherein the first communication coupling module comprises:
a first internal communication unit;
a first external communication unit, configured to control the first mobile communication module to perform communication;
a first voice processing unit, configured to convert voice data received by the first portable device into audio signals, and convert audio signals received by the first portable device into voice data; and
a first control unit, configured to control the first internal communication unit, the first external communication unit and the first voice processing unit according to the communication operation;
the second communication coupling module comprises:
a second internal communication unit, configured to link with the first internal communication unit;
a second external communication unit, configured to control the second mobile communication module to perform communication;
a second voice processing unit, configured to convert voice data received by the second portable device into audio signals, and convert audio signals received by the second portable device into voice data; and
a second control unit, configured to control the second internal communication unit, the second external communication unit and the second voice processing unit according to the communication operation.

3. The communication integration system of claim 1, wherein the first communication coupling module comprises:
a first internal communication unit;
a first external communication unit, configured to control the first mobile communication module to perform communication; and
a first control unit, configured to control the first internal communication unit and the first external communication unit according to the communication operation;
the second communication coupling module comprises:
a second internal communication unit, configured to link with the first internal communication unit;
a second external communication unit, configured to control the second mobile communication module to perform communication;
a voice processing unit, configured to convert voice data received into audio signals, and convert audio signals into voice data; and
a second control unit, configured to control the second internal communication unit, the second external communication unit and the voice processing unit according to the communication operation.

4. The communication integration system of claim 1, wherein the first and second communication coupling modules are built by software or firmware.

5. The communication integration system of claim 1, wherein the first and second communication coupling modules are periphery devices external to the first and second portable devices.

6. The communication integration system of claim 1, wherein the first and second communication coupling modules are embedded hardware of the first and second portable devices.

7. The communication integration system of claim. 1, wherein the first and second communication coupling modules are linked through an internal transmission means, and the internal transmission means comprises digital enhanced cordless telecommunication (DECT), Wi-Fi, Bluetooth, Zigbee, infrared, universal serial bus (USB) or Ethernet.

8. A communication integration method, comprising:
linking a first portable device to a second portable device, the first portable device comprising a first mobile communication module configured to perform communication via a first mobile communication network, and a first communication coupling module coupled to the first mobile communication module, the second portable device comprising a second mobile communication module configured to perform communication via a second mobile communication network, and a second communication coupling module configured to link with the first communication coupling module, the second communication coupling module being coupled to the second mobile communication module;
utilizing the first mobile communication module to communicate with a communication device;
transmitting communication data and first voice data received by the first portable device to the second communication coupling module;
displaying the communication data and playing the first voice data on the second portable device;
transmitting second voice data of the second portable device to the first communication coupling module; and
transmitting the second voice data from the first mobile communication module to the communication device.

9. The communication integration method of claim 8 further comprising the first and second portable devices mutually transmitting data via the first and second communication coupling modules, wherein the data comprises phone book data, social network data, Internet communication data and/or short message data.

10. The communication integration method of claim 8, wherein the first portable device utilizing the first mobile communication module to communicate with the communication device comprises:
the second portable device controlling the first portable device via the first and second communication coupling modules, for utilizing the first mobile communication module to communicate with the communication device.
